(19) United States
(12) Patent Application Publication
(10) Pub. No.: US 2004/0073705 A1
(43) Pub. Date: Apr. 15, 2004

(54) Print preview with edit hyperlink

(76) Inventors: Robert John Madril JR., Boise, ID (US); Shell Sterling simpson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/281,082

(22) Filed: Oct. 15, 2002

(51) Int. Cl. G06F 15/16

(52) U.S. Cl. 709/245; 709/217

(57) ABSTRACT

Method and apparatus for providing an edit hyperlink within a production system includes generating a link to an editable document at a different web site location than the production system. The production system does not need to know anything about editing the document.

### TECHNICAL FIELD OF THE INVENTION

The present invention relates generally to generating a hyperlink for a print preview page.

### BACKGROUND OF THE INVENTION

Desktop applications for computers take on a myriad of functions. Specialized programs are used to generate documents, play games, fill out checks, assist in publishing newsletters and brochures, and the like. Many desktop applications are used to generate materials that are to be printed, for example using any of a variety of printers. Many desktop applications support an integrated preview mechanism. Such a mechanism allows a user to view a representation of what the program believes the document being previewed will look like when the document is printed on a printer. Desktop application preview mechanisms provide a fairly seamless preview cycle, and allow the user to click a button or move to a different view for editing the document should the desire to edit arise during the preview procedure.

However, desktop applications such as those described, with integrated preview mechanisms, do not provide a true preview of what the actual printed page will look like. Instead, such applications provide their previews within the context of the application itself. Therefore, certain parameters are unknown to the application. These parameters include by way of example only and not by way of limitation, actual paper size on which the document is to be printed, the paper type, advanced features of the printer on which the document will be printed such as n-up, booklet printing capabilities, stapling abilities, duplex printing abilities, and the like. The application uses only the knowledge of the document, and makes various assumptions about any remaining parameters without truly knowing how those parameters will apply to the final printed product. The print preview of such applications is provided within the desktop application, not within the production system directly.

Further, with the continued advances in computer technology, and with the ever-increasing availability and utility of global networks such as the world wide web, providers of internet type services have begun to branch out into offering services that were not previously viable. Such services include provision of applications over the internet (typically by entities known as application service providers or ASPs), web based E-mail applications, web based imaging, and the like.

Further, once a document is fully ready for printing, and has been presented to the production system of the particular printer, it is difficult to “go back” to edit the document without closing out of the print application, finding the part of the document to be edited, editing, and re-presenting to the production system. Because of the large number of application specific formatting issues in most applications, it is not feasible for a printer to edit documents.

A separate application like FinePrint allows a user to preview a document outside the program in which it was created, but only in a limited sense. The program captures the document before it is printed and applies certain generic printing options to the document. FinePrint, like the actual applications that generate the documents, cannot apply the document to an actual production system, and therefore also provides an inaccurate view of how the document will appear when printed or otherwise produced.

There is a need in the art for improved editing capabilities from a production system.

### SUMMARY

For one embodiment, a method of providing a web based link to edit a document includes deriving a reference for the document, and placing a link containing the reference on a preview page of the document.

For another embodiment, a method of generating a link to an editable document from a production system includes gathering document information from the document, using the document information to generate a location URL for the document, and placing a hyperlink on a preview web page of the production system containing the generated URL.

Other embodiments are described and claimed.

### BRIEF DESCRIPTION OF THE DRAWINGS

FIG. 1 is a flow chart diagram of a method according to one embodiment of the present invention;

FIG. 2 is a flow chart diagram of a method according to another embodiment of the present invention; and

FIG. 3 is a block diagram of a web application on which embodiments of the present invention are practiced.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

Various embodiments of the invention described below provide a link within a production system to an editable page of a document external to the production system, such as a page in a source document application, or source web application. The production system may be provided in a web application. A web application is an application that exposes its user interface through a web browser, for example a web site providing application-like capabilities (e.g. email). The link in the production system is to an external web page not controlled by the production system. The production system needs to know nothing about the edit page except how to direct the user's browser to the edit page. Therefore, all that is necessary for the linking to the external web page is a reference such as a uniform resource locator (URL) that, in one embodiment, is derived or provided by the application or web page that originally generated the document.

A link is also referred to as a hyperlink, or hypertext link. A hyperlink is data, as text, graphics, or sound, stored in a computer so that a user can move nonsequentially through a link from one object or document to another. A link is a selectable connection from one word, picture, or information object to another. In a multimedia environment such as the World Wide Web, such objects can include sound and motion video sequences. The most common form of link is the highlighted word or picture that can be selected by the user (with a mouse or in some other fashion), resulting in the immediate delivery and view of another file.

For one embodiment, FIG. 1 illustrates a method 100 of providing or generating an edit hyperlink. A document preview is generated in a production system in block 102, from a document in a stand alone word processor or the like, or from a web application representing a word processor, and a link to an editable version of the document is provided in block 104. The editable version of the document is, in one embodiment, generated by either a third party document editor accessible for example through a web link, or by the source program in which the original document was created, either on a web site or at a known linkable location. The link, in one embodiment, is a clickable button containing a hypertext markup language (HTML) reference to a specific location (specified by a uniform resource locator (URL)) that contains the document to be edited.

When the link is clicked, or activated, the user's browser is opened and directed to, or a user's open browser is redirected to another location, in the existing browser window or a new browser window, at the address supplied in the link in block 106. From for example a document preview in a word processor document of a stand-alone word processor, when the edit link is activated, the user's browser is opened, and the browser is directed to the URL contained in the link. If the production system is a web application, an open user browser may be redirected to the URL contained in the link. This link is, for example, an edit page generated by a source web application. The user's browser is directed or redirected from viewing the production web page to viewing the editing web page. The production system does not need to know any of the particulars of the document which is to be edited, nor does the production system need to know anything about the source program which is used to edit the document. All the production system needs is the link to which the user's browser is directed to display when the URL button or hyperlink is clicked. In one embodiment, this hyperlink, and not the document itself, is supplied when a production request is sent to the production system. The production system places the link in a location accessible to the user so that the user's browser can be directed to the edit page from the production system. An “edit” button can be placed on the preview page so that the user can click through to the edit page directly from the preview page.

The web page in question is the web page of a printing service or a production service. The service provides a preview of the document in the context of the production service. The preview is useful because it contains an accurate representation of what the document will actually look like when it is printed or otherwise produced.

The hyperlink provided for the preview page is generated using the document that is being previewed. A reference to the location of the document is embedded in the document. The reference to the location is derived or retrieved from the document, either from the document data or by making remote procedure calls to a service that represents the document, by the production system, or is sent to the production system with the production request. The reference may take the form of a redirection URL containing the information the web application uses to redirect to the production site, as well as an addendum to the redirect URL containing a reference specifying the document location. The web page providing the preview, such as a printing service or production service, synthesizes the link to an editable document based on the information gathered or received from the document or the production request, or from information received after a production system request to the document. The link may contain a reference to a web site where the document can be edited external to the production system, along with a reference to the document itself. Such a web site may identify the base location for the browser to be directed to for document editing services, along with a specific reference to document data and its location, and may further contain information as to a location to store the document once it is changed or otherwise modified. An example of a hyperlink containing information on document editing services and document data is http://www.docedit.com?docref=http://docstore.com/12345678.pdf, where the initial URL www.docedit.com provides document editing services and the second (embedded) URL docstore.com contains the document data.

In another embodiment, the hyperlink to a location where the document can be edited is gathered from or supplied by an agent of the document, such as its storage device or web application, directly. In this embodiment, a URL or a list of URLs where the document is editable is supplied. In the emerging world of web applications, a direction through a web application in which the user's browser is directed to a web site running the application, such as through an application service provider (ASP) or the like, is quick and easy. Web applications are viewed as providing a web interface through which documents corresponding to the web application in question are editable. The same web applications provide a programmatic interface to the document to allow it to be edited, linked to, saved as a new version, and the like. The web application, when provided with the document identity, provides a link for the preview page to an editable version of the document. As has been mentioned, the production system does not need to have any knowledge of the application or the edit program or page. The web application gathers or retrieves sufficient information when the document reference is presented by the production system to provide the link to the editable page

Accessing a production system in a web based environment allows a number of advantages including by way of example only and not by way of limitation the ability to generate or synthesize hyperlinks, within the production system, to an actual editable version of the document

In another embodiment, the actual data contained in the document is not passed between the web application representing the document creator and the web application representing the production system. Instead, a reference to the data is passed. The reference to the data contains sufficient information about the location of the document to allow retrieval of the data or relevant portions thereof for previewing. For example, the reference to the data may be used to generate an edit link. Passing a reference instead of the underlying data is quicker than sending the underlying data. Further, when resolving a reference, the resolution is typically more accurate than the data, since the data can change, but the reference presumably links to the proper data, changed or not.

One embodiment of the present invention uses identity services such as those anticipated for use on the Internet today. The identities can contain personal information about a user, such as airline preferences, book purchase preferences, and the like. This embodiment retrieves a user identity or identities relating to printing and document access to create the links described above. Identities for the purposes of this application are services that represent a user, including other entities, web services or even devices that can be accessed to gain information about the user and supply information that is relative to the particular user, such as preferred seating arrangements on airplanes, preferred car rental type, and the like. An identity service is a web service that provides access to information, such as that contained in a specific user identity, associated to a specific user

Examples of identity services are known under names such as wallet, itinerary, travel, car rental, and the like. For example, a wallet identity stores information about a user including name, address, credit card information, and the like, and can be used to make payment without entering a large amount of information, because the information is already present in the wallet identity.

In another embodiment, information associated with the user (identity information) related to printing and document access is gathered from or provided by the identity service. For example, identity information includes in one embodiment active document and selected document, preferred printing, printer preferences, and the like. Identity information is stored in identity services which make the identity information accessible to other parties. Each of the identity services stores information pertinent to a specific identity, which is typically an end-user. The elected document identity service contains information relating to the currently selected document, such as a reference to that document, for example the document to be previewed with the production system. The preferred printing identity service contains information relating to a printer bank, a specific printer, a web location of a print or production system service, or the like, that is identified with the particular user. The preferred printing identity service contains a reference (i.e. a URL) to the web site where the user prefers to browse after making a print request. The identity services are used in conjunction with the web applications to provide information about documents and production systems without requiring extensive contemporaneous data entries by the user.

When a user creates a document, the document source application, be it a web application or a desktop application, stores or saves information relating to the document therein, either with the document or with the document source application, and/or with an identity service such as favorite documents, selected document, or the like.

Within the source web application, a print button may be enabled. When the user clicks an enabled print button in the source web application, the web application places or stores information about the document that is to be printed into a selected document identity service. Then it accesses a preferred printing destination identity service to find out which URL the web site browser should be redirected to in order to allow the user to print, according to preferences contained in the preferred printing identity service.

When the user wishes to print using a printer or production system, the source web application in one embodiment accesses the preferred printing identity service to determine what application or production system the user prefers for production of the document, and accesses that production system. In the production system, the selected document identity service is accessed to obtain the information related to the document to be produced. Once the information about the document is known, the production system either links to the document applying printing preferences, or retrieves the actual document for display given the printing preferences.

The source may be a web application, for instance a word processor, Mapquest, or the like, or may be a traditional desktop application. The source does not know or need to know anything about the destination or production system web application. It is sufficient that each of the source web application and the production system support an identity based protocol, such as for printing or the like.

The URL generated or retrieved by the source web application accessing a preferred printing identity service may be for example a web service (i.e. a web service providing access to the document). A web service is a network service that is implemented using for example simple object access protocol (SOAP). SOAP is a lightweight remote procedure call protocol designed to be used in a decentralized, distributed environment. It is an extensible markup language (XML) based protocol that consists of three parts, an envelope that defines a framework for describing what is in a message and how to process it, a set of encoding rules for expressing instances of application-defined datatypes, and a convention for representing remote procedure calls and responses. Web services need not be accessed by SOAP. Web services could also be, for example, services that are programmatically accessed through a remote procedure call mechanism based on web standards such as xml, http, and SOAP.

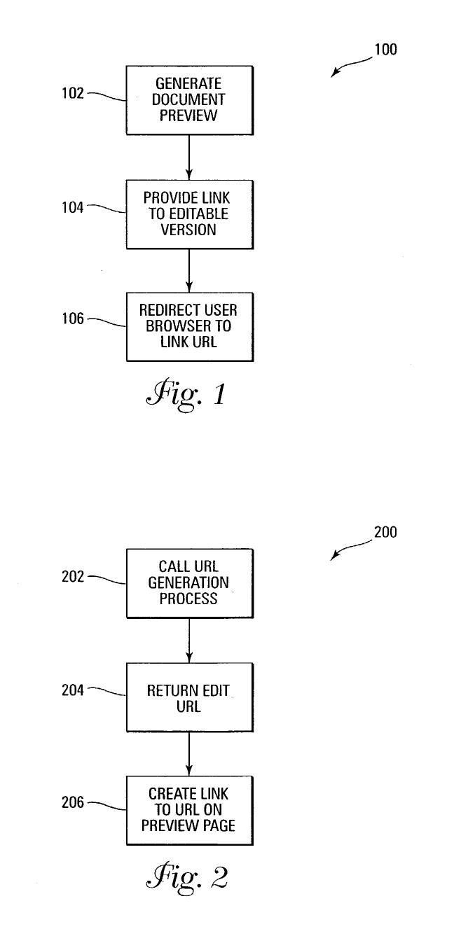

For another embodiment, FIG. 2 illustrates a method 200 for generating a link to an editable page for a document. A document object is called from a web application representing a printer. This process returns a URL to a location where the document is editable in block 202. The location may be the location of the document itself, at a document URL, ormay be to an editable version of the document at an edit URL. As a whole, editing a document from a production system is difficult. Typically, production systems are for previewing pages so that a user can see how the page will look when it is printed. If the user sees an error in a preview page, the user typically wants to edit the document. The method allows the web application representing the printer to have a link on the web page where it provides a preview, which when clicked, links the user's browser to the location referenced by the document URL or edit URL that the document object supplies.

The web application representing the printer does not need to know anything about how to edit a document. All it needs to know is to call the method on the document object, which returns a location or edit URL in block 204. Then, the production system creates a link on the preview page that the user can click in block 206. The link points to the URL supplied by or generated from the document. When the user clicks on that link, the user's browser is redirected to the editing page and the document can be edited. The user gets the original document editing experience at the point where the document is ready to print.

The link to the document that is presented in the production system is generated in various ways. For example, the link may be generated through the document itself. An object (such as a SOAP object) represents the document. The document object is called in one of a number of ways. Before calling the document object, the location of the document object is determined. In one embodiment, the document object is identified by a URL obtained from an identity service, such as the selected document identity service, that provides information about and access to the active document. This URL is in for example a SOAP “endpoint” of the document object. Once the SOAP “endpoint” is known, methods are invoked on the document object using the SOAP protocol. To provide the preview images, the document object may be called to provide a link to a preview web page. This link is provided to the user so the user can activate the link and the user's browser is directed to a preview web page. By clicking on the preview link the user is redirected to a web page that provides a preview of the document.

The web application representing the printer in which access is provided to a preview through a link to a web page where the preview is available does not retrieve the actual document or its content. Instead, it redirects the user's browser to a location at which the content is displayed. The web application representing the printermay be embedded in the printer itself. It is the web application representing the printer that has the link to the editable material. It does not have the editable material.

When the web application representing the printer synthesizes the web page that it serves to the end user's browser, it includes in the content that it synthesizes a link to the edit page so that when the user clicks on that link in a browser, the browser is redirected to the URL contained in the link.

Within the production system, preview pages are shown in pre-production to allow a user to view a representation of what the document being previewed will look like when it is printed. Preview pages are generated and displayed in various ways, for example, the document object has methods that provides URLs to preview images, or the production system integrates references to the preview pages into the web pages it generates in order to show a preview. A web page and the graphics shown on a web page do not necessarily come from the same location. Similarly, the production system web page and the graphics displayed as part of that web page can come from different web servers.

The document preview can be accomplished in a number of different ways. The preview is for example provided by a completely different website than the production web site, or is provided by obtaining graphics of the pages of the document from the document object. The page images may be modified by the production website and then included in the production website's web pages. The preview may also be provided by obtaining references to graphics of the pages that are stored or maintained on a machine associated with the document object and including these graphics in the production websites web pages.

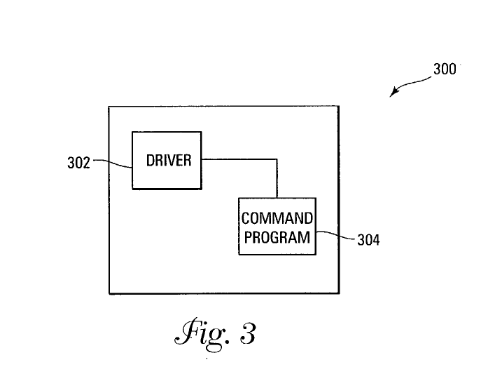

A computer program representing a web application that represents a production system 300 is shown in FIG. 3. The system includes a production system driver 302, and a command program 304 for operating the production system driver. The command program is a set of machine readable instructions that cause a computer, the web application representing the production system, or a web application representing a document generator to execute the methods described above. For example, when a user wishes to print a page, document, or the like, a request or call to print is initiated, typically through a menu or a specific button in the document generation or source web application. Upon initiation of the printing request, the web application representing a production system is activated through its command program.

The command program obtains the URL at which the document to be produced is located, through one of the methods described above. Once the command program has the URL, the command program places an edit button on a preview page for the document. The edit button may be a hyperlink to the URL at which the document is located. When the user desires to edit the document being previewed, the user clicks the edit button and the user's browser is redirected to the edit page.

When the user chooses print, the document data (obtained through one of the methods described above) is translated into a form suitable to be processed by the desired printer. The translation process is depicted as being accomplished through a printer driver, however, this is only representative. Any technology capable of converting the source data into data capable of being processed by the production devices is suitable.

The various embodiments of the present invention separate a printing user interface from a document production interface. The embodiments of the invention use two web applications, each having a specific purpose and specialty. One web application such as a word processor or the like does the document production. The second web application does the printing and print previewing. The document production web application has the editing capabilities, and the print web application has the print preview and printing production capabilities. Therefore, the print preview within the web application representing the printer is a good print preview. The link provided for editing, as generated by one of the various methods described above, allows the user to be linked directly to an editable version of the document from within the print preview. So, the embodiments of the present invention provide a true print preview with a generated link on the print preview, where the link redirects the user to an editable version of the document.

Once the user is at the edit page, the user can edit the document and return to the production system using the methods and apparatus further described in U.S. patent application entitled EDITING A DOCUMENT WITHIN WEB-BASED PRODUCTION SYSTEM (Atty. Docket No. 10019464) owned by the assignee to the present application, which is hereby incorporated by reference in its entirety.

The methods shown in the Figures may be implemented in whole or in part in various embodiments in a machine readable medium comprising machine readable instructions for causing a computer or a web application to perform the methods. The computer programs run in a computer on a central processing unit out of main memory, and may be transferred to main memory from permanent storage via disk drive or CD-ROM drive when stored on removable media or via a network connection or modem connection when stored outside of the computer, or via other types of computer or machine readable media from which it can be read and utilized. The computer programs run as sub-modules of a web application when running in that context.

Such machine readable media may include software modules and computer programs. The computer programs may comprise multiple modules or objects to perform the methods in the Figures or the functions of various apparatus of the Figures. The type of computer programming languages used to write the code may vary between procedural code type languages to object oriented languages. The files or objects need not have a one to one correspondence to the modules or method steps described depending on the desires of the programmer. Further, the methods and apparatus may comprise combinations of software, hardware and firmware as is well known to those skilled in the art.

### Conclusion

Methods and apparatus for generating a hyperlink for a print preview page, the hyperlink containing a link to an editable page for the document being previewed have been described herein. The hyperlink is generated through reference to the actual document from which it is generated, or from reference to the web application in which the document is generated. Another generation method for the hyperlink is to use one or more identity services. The identity services in one embodiment are an identity service for a preferred production system or printing system, and an identity service for a selected document. The identity services are used to provide locations and links for where the document, editable document, and the printing system are located on the world wide web.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

What is claimed is:

1. A method of providing a web based link to edit a document, comprising:
deriving a reference for the document; and
placing a hyperlink containing the reference on a preview page of the document.

2. The method of claim 1, wherein deriving the reference comprises:
obtaining the reference from the document.

3. The method of claim 1, wherein deriving the reference comprises:
obtaining document information through an identity service.

4. The method of claim 3, wherein obtaining document information comprises:
accessing a preferred printing destination identity service from a source application of the document to obtain a printing destination;
accessing a selected document identity service from the printing destination to obtain a reference to a document object; and
creating an edit link in the printing destination application for the selected document with the reference provided by the selected document object.

5. The method of claim 1, wherein deriving the reference comprises:
obtaining the reference from an application that created the document.

6. The method of claim 1, wherein deriving a reference comprises deriving a uniform resource locator (URL).

7. A method of generating a link to an editable document from a production system, comprising:
gathering document information from the document;
using the document information to generate a location URL for the document; and
placing a hyperlink on a preview web page of the production system containing the generated URL.

8. A method of generating a link to an editable document from a production system, comprising:
gathering document information from a reference generated by a web application on which the document was created;
using the document information to generate an edit URL for the document; and
placing a hyperlink on a preview web page of the production system containing the generated URL.

9. A method of generating a link to an editable document from a production system, comprising:
gathering a reference to a document from an identity service providing information regarding an active document;
using the document information to generate an edit URL for the document; and
placing a hyperlink on a preview web page of the production system containing the generated URL.

10. A method for generating an edit hyperlink to a document, comprising:
deriving an edit uniform resource locator (URL) for the document; and
placing a link containing the edit URL on a preview page of a web application representing a preferred production system.

11. The method of claim 10, wherein deriving an edit URL comprises:
accessing an identity service to obtain a preferred production system from a web application representing a source of the document; and
accessing a second identity service from the preferred production system to obtain a URL for the document.

12. The method of claim 10, wherein deriving an edit URL comprises:
accessing the document; and
determining from the document the URL at which the document is located.

13. The method of claim 12, wherein accessing the document is accomplished using a remote procedure call mechanism.

14. The method of claim 13, wherein the remote procedure call mechanism is Simple Object Access Protocol (SOAP).

15. The method of claim 10, wherein deriving an edit URL comprises:
attaching edit URL information to a redirection URL reference passed from a web application at which the document was created to a production system; and
retrieving the edit URL from the reference.

16. A method of providing an edit hyperlink for a document in a web application, comprising:
initiating a web application representing a production system;
obtaining a uniform resource locator (URL) to an editable version of the document;
accessing a production system for the document;
generating a document preview in the production system; and
placing a link containing the URL in the document preview.

17. The method of claim 16, wherein obtaining a URL comprises:
accessing a document object containing information about the document; and
retrieving the URL to the editable version of the document from the document object.

18. The method of claim 16, wherein obtaining a URL comprises:
accessing the document; and
retrieving document information from the document.

19. The method of claim 18, wherein accessing the document is accomplished using a remote procedure call mechanism.

20. The method of claim 19, wherein the remote procedure call mechanism is Simple Object Access Protocol (SOAP).

21. The method of claim 16, wherein accessing a production system comprises:
accessing a preferred production system identity service; and
retrieving a URL to a web application representing the production system.

22. A method of generating an edit hyperlink to a document within a production system, comprising:
accessing the production system from a web application in which the document was created;
passing a reference to the document to the production system; and
embedding the reference to the document within a hyperlink on a preview page of the document within the document production system.

23. The method of claim 22, wherein passing a reference comprises:
obtaining a reference to the location of the document from a redirection URL; and
obtaining a reference to a web site at which the document can be edited from the document.

24. The method of claim 23, wherein obtaining a reference to the location of the document comprises:
accessing a selected document identity service that provides the location of the document.

25. The method of claim 23, wherein obtaining a reference to the location of the document comprises:
synthesizing the location based on a type of the document.

26. A method of providing an edit hyperlink for a document at a production system, comprising:
initiating a print request to the production system from a web application representing a document creator;
passing a reference for the document to a web application representing the production system;
generating a production preview of the document in the production system; and
providing a link to an editable version of the document in the production preview, the link containing the reference.

27. The method of claim 26, wherein the reference for the document is obtained from a redirection reference used to redirect a user browser from the web application representing the document creator to the web application representing the production system.

28. The method of claim 26, wherein passing a reference comprises passing a uniform resource locator (URL).

29. A machine readable medium having a set of machine readable instructions for causing a processor to perform a method comprising:
deriving a uniform resource locator (URL) for a document; and
placing a link containing the URL on a preview page of the document within a production system.

30. The machine readable medium of claim 29, wherein deriving a URL comprises:
accessing an identity service to obtain a preferred production system from a web application representing a source of the document; and
accessing a second identity service from the preferred production system to obtain a URL for the document.

31. The machine readable medium of claim 29, wherein deriving a URL comprises:
accessing the document; and
determining from the document the URL at which the document is located.

32. The machine readable medium of claim 31, wherein accessing the document is accomplished using a remote procedure call mechanism.

33. The machine readable medium of claim 32, wherein the remote procedure call mechanism is Simple Object Access Protocol (SOAP).

34. The machine readable medium of claim 34, wherein accessing the web application at which the document was created comprises:
accessing a document object containing information about the document; and
retrieving the URL to the editable version of the document from the document object.

35. A machine readable medium having machine readable instructions for causing a processor to perform a method of providing an edit hyperlink to an editable document on a preview page in a production system, the method comprising:
determining an edit uniform resource locator (URL) for a web page where the document can be edited;
previewing the document; and
placing an edit hyperlink containing the determined URL for the editable document on the preview page of the document.

36. The machine readable medium of claim 35, wherein determining comprises:
accessing a document object; and
retrieving document information from the document object.

37. The machine readable medium of claim 35, wherein determining comprises:
accessing the document; and
retrieving document information from the document.

38. The method of claim 37, wherein accessing the document is accomplished using a remote procedure call mechanism.

39. The method of claim 38, wherein the remote procedure call mechanism is Simple Object Access Protocol (SOAP).

40. The machine readable medium of claim 35, wherein determining comprises:
accessing an identity service for the document;
retrieving a document object URL from the identity service; and
retrieving the edit URL from the document object.

41. A machine readable medium having machine readable instructions for causing a processor to perform a method, comprising:
gathering document location information from an identity service representing a document;
using the document location information to access a document object containing document information;
generating an edit URL for the document from the document object; and
placing a hyperlink to the edit URL on a preview web page of a production system.

42. A web application representing a production system, comprising:
a production system driver module; and
a preview command module having machine readable instructions for causing the web application to perform a method comprising:
deriving a uniform resource locator (URL) for editing a document that is to be produced by the web application; and
placing a link containing the URL on a preview page of the document.

43. A method, comprising:
displaying a document selected for printing; and
placing a hyperlink to an editable version of the document in the document display.

44. A method, comprising:
generating a non-editable version of a document;
hyperlinking the non-editable version of the document to an editable version of the document; and
displaying the hyperlink in the non-editable version of the document.

45. A method, comprising:
generating a non-editable version of a document in a production system;
hyperlinking the non-editable version of the document to an editable version of the document at a location external to the production system; and
displaying the hyperlink in the non-editable version of the document.
